(19) United States
(12) Patent Application Publication
(10) Pub. No.: US 2026/0261355 A1
(43) Pub. Date: Sep. 3, 2026

(54) OPTICAL COMMUNICATION DEVICE, OPTICAL AMPLIFIER, AND OPTICAL AMPLIFICATION METHOD

(71) Applicant: 1FINITY Inc., Kawasaki-shi (JP)

(72) Inventors: Shun OKADA, Kawasaki (JP); Kyosuke SONE, Kawasaki (JP)

(73) Assignee: 1FINITY Inc., Kawasaki-shi (JP)

(21) Appl. No.: 19/549,948

(22) Filed: Feb. 25, 2026

(30) Foreign Application Priority Data
Feb. 28, 2025 (JP) 2025-032413

(51) Int. Cl. H04J 14/02; H04B 10/291; H04B 10/294; H04B 10/297

(52) U.S. Cl. CPC H04J 14/02216; H04B 10/2916; H04B 10/294; H04B 10/297

(57) ABSTRACT

An optical communication device includes a splitter, a first amplifier, a second amplifier, and a combiner. The splitter demultiplexes input signal light into first signal light and second signal light. The first signal light is amplified by the second amplifier after being amplified by the first amplifier. The second signal light is amplified by the first amplifier after being amplified by the second amplifier. The combiner multiplexes the amplified first signal light and the amplified second signal light.

### CROSS-REFERENCE TO RELATED APPLICATION

This application is based upon and claims the benefit of priority of the prior Japanese Patent Application No. 2025-032413, filed on February 28, 2025, the entire contents of which are incorporated herein by reference.

### FIELD

The embodiments discussed herein are related to an optical communication device, an optical amplifier, and an optical amplification method.

### BACKGROUND

In order to expand the transmission capacity of optical communication networks, multiband optical transmission using a plurality of wavelength bands is effective. In recent years, for example, optical communication devices, which use ion-doped fiber amplifiers, semiconductor optical amplifiers, and Raman amplifiers for optical amplification of C-band, L-band, and S-band signal light in multi-band wavelength division multiplexing (WDM) systems, have been considered. The related technologies are described, for example, in: U.S. Patent No. 6882466 and Japanese Laid-open Patent Publication No. 9-83270.

However, when the optical communication devices in the related art use, for example, Raman amplifiers that optically amplify signal light in a plurality of wavelength bands, cross phase modulation (XPM) occurs by wavelength division amplification of the signal light. As a result, the nonlinear signal to noise ratio (SNR) of the signal light is degraded by the XPM.

### SUMMARY

According to an aspect of an embodiment, an optical communication device includes a splitter, a first amplifier, a second amplifier and a combiner. The splitter demultiplexes input signal light into first signal light and second signal light. The first signal light is amplified by the second amplifier after being amplified by the first amplifier. The second signal light is amplified by the first amplifier after being amplified by the second amplifier. The combiner multiplexes the amplified first signal light and the amplified second signal light.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an explanatory diagram illustrating an example of an optical amplifier of a first example;

FIG. 2 is an explanatory diagram illustrating an example of simulation results between the optical amplifier of the first example and an optical amplifier of a first comparative example;

FIG. 3 is an explanatory diagram illustrating an example of an optical amplifier of a second example;

FIG. 4 is an explanatory diagram illustrating an example of an optical amplifier of a third example;

FIG. 5 is an explanatory diagram illustrating an example of an optical amplifier of a fourth example;

FIG. 6 is an explanatory diagram illustrating an example of an optical amplifier of a fifth example;

FIG. 7 is an explanatory diagram illustrating an example of the optical amplifier of the first comparative example; and

FIG. 8 is an explanatory diagram illustrating an example of an optical amplifier of a second comparative example.

### DESCRIPTION OF EMBODIMENTS

For example, in the development of band extension nodes that handle S-band, C-band, or L-band signal light, the application of a lumped Raman amplifier for amplifying S-band signal light is being considered. However, due to the limitation of the amount of gain that is obtained with a single amplification fiber, the lumped Raman amplifier needs to amplify signal light by forming a multi-stage configuration using a plurality of amplification fibers, for example, by forming a two-stage configuration using two amplification fibers. For example, attempting to amplify signal light with a single amplification fiber by rapidly increasing the amount of gain may lead to degradation in signal light quality. In this regard, for example, an optical amplifier in a first comparative example, which amplifies the optical power of S-band WDM signals with a two-stage configuration by using two lumped Raman amplifiers, is considered.

### First Comparative Example

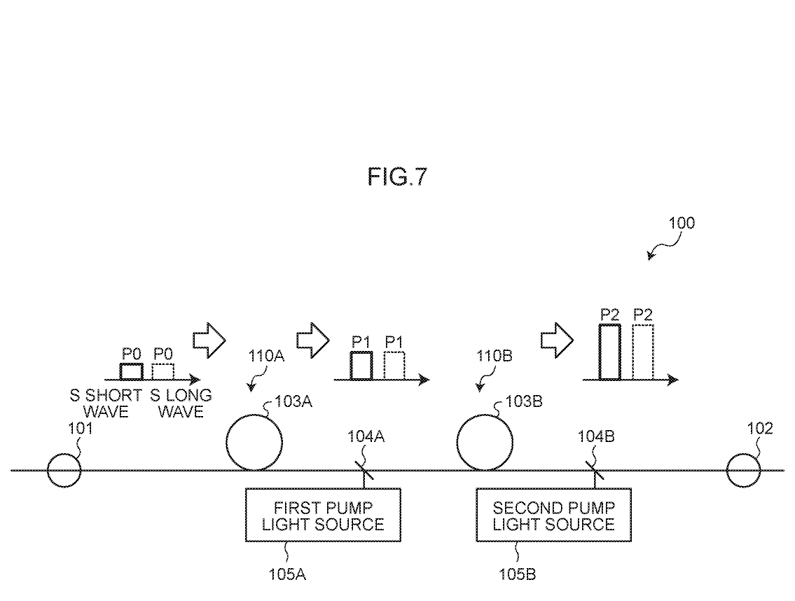

FIG. 7 is an explanatory diagram illustrating an example of an optical amplifier 100 of the first comparative example. The optical amplifier 100 illustrated in FIG. 7 includes an input unit 101, an output unit 102, a first amplification unit 110A, and a second amplification unit 110B. The input unit 101 is, for example, an input unit of the optical amplifier 100 that inputs S-band signal light within a wavelength division multiplexing (WDM) signal. The S-band signal light includes, for example, signal light in a short wavelength band of an S-band and signal light in a long wavelength band of the S-band. The output unit 102 is an output unit of the optical amplifier 100 that outputs the S-band signal light after optical amplification.

For convenience of explanation, the optical power of the signal light passing through the optical amplifier 100 is optically amplified stepwise in the order of P0, P1, and P2, for example. The gain amounts of the first amplification unit 110A and the second amplification unit 110B are assumed to be approximately the same. The optical power P0 is the optical power of the signal light before optical amplification at an input stage of the first amplification unit 110A. The optical power P1 is the optical power of the signal light after the first optical amplification at an output stage of the first amplification unit 110A and an input stage of the second amplification unit 110B. The optical power P2 is the optical power of the signal light after the second optical amplification at an output stage of the second amplification unit 110B.

The first amplification unit 110A optically amplifies the signal light in the short wavelength band of the S-band and the signal light in the long wavelength band of the S-band, which are input from the input unit 101, and inputs the signal light in the short wavelength band of the S-band and the signal light in the long wavelength band of the S-band after the optical amplification to the second amplification unit 110B. The first amplification unit 110A includes a first amplification fiber 103A, a first pump light source 105A, and a pump WDM filter 104A disposed at the rear stage of the first amplification fiber 103A. The first amplification fiber 103A is, for example, a Raman amplification fiber that, in response to pump light, optically amplifies the signal light in the short wavelength band of the S-band and the signal light in the long wavelength band of the S-band, which are input from the input unit 101. The first pump light source 105A is a light source that emits the pump light for exciting the first amplification fiber 103A. The pump WDM filter 104A is a filter that is disposed between the first amplification fiber 103A and a second amplification fiber 103B and inputs the pump light from the first pump light source 105A into the first amplification fiber 103A.

That is, the first amplification fiber 103A optically amplifies the optical power P0 of the signal light in the short wavelength band and the optical power P0 of the signal light in the long wavelength band, which are input from the input unit 101, to the optical power P1 of the signal light in the short wavelength band and the optical power P1 of the signal light in the long wavelength band, respectively.

The second amplification unit 110B optically amplifies the signal light in the short wavelength band of the S-band and the signal light in the long wavelength band of the S-band, which are input from the first amplification unit 110A, and inputs the signal light in the short wavelength band of the S-band and the signal light in the long wavelength band of the S-band after the optical amplification to the output unit 102. The second amplification unit 110B includes a second amplification fiber 103B, a second pump light source 105B, and a pump WDM filter 104B disposed at the rear stage of the second amplification fiber 103B. The second amplification fiber 103B is, for example, a Raman amplification fiber that, in response to pump light, optically amplifies the signal light in the short wavelength band of the S-band and the signal light in the long wavelength band of the S-band, which are input from the first amplification fiber 103A. The second pump light source 105B is a light source that emits the pump light for exciting the second amplification fiber 103B. The pump WDM filter 104B is a filter that is disposed between the second amplification fiber 103B and the output unit 102 and inputs the pump light from the second pump light source 105B into the second amplification fiber 103B.

That is, the second amplification fiber 103B optically amplifies the optical power P1 of the signal light in the short wavelength band and the optical power P1 of the signal light in the long wavelength band, which are input from the first amplification fiber 103A, to the optical power P2 of the signal light in the short wavelength band and the optical power P2 of the signal light in the long wavelength band, respectively, and outputs the amplified signal light to the output unit 102.

In the second amplification fiber 103B at the output stage, the total power is P4 (= P2 + P2) because the optical power of the signal light in the short wavelength band is P2 and the optical power of the signal light in the long wavelength band is P2.

In the optical amplifier 100 of the first comparative example, the total power in the second amplification fiber 103B at the output stage increases, resulting in an increase in XPM, and a nonlinear SNR is degraded by the increase in XPM. Therefore, an optical amplifier 100A of a second comparative example that can suppress degradation of the nonlinear SNR of the optical amplifier 100 of the first comparative example is also considered.

### Second Comparative Example

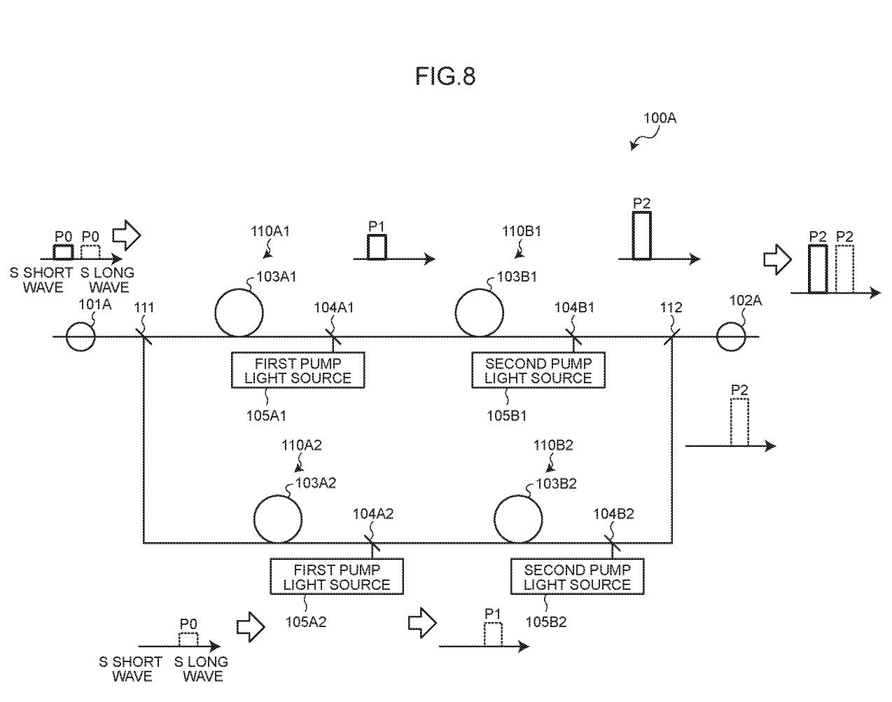

FIG. 8 is an explanatory diagram illustrating an example of the optical amplifier 100A of the second comparative example. The optical amplifier 100A illustrated in FIG. 8 includes an input unit 101A, an output unit 102A, a demultiplexing unit 111, and a multiplexing unit 112. The optical amplifier 100A further includes a first amplification unit 110A1, a second amplification unit 110B1, a third amplification unit 110A2, and a fourth amplification unit 110B2. The input unit 101A is, for example, an input unit of the optical amplifier 100A that inputs S-band signal light within a wavelength division multiplexing (WDM) signal. The S-band signal light includes, for example, signal light in the short wavelength band of the S-band and signal light in the long wavelength band of the S-band. The output unit 102A is an output unit of the optical amplifier 100A that outputs the S-band signal light after optical amplification.

For convenience of explanation, the optical power of the signal light passing through the optical amplifier 100A is optically amplified stepwise in the order of P0, P1, and P2, for example. The gain amounts of the first amplification unit 110A1, the second amplification unit 110B1, the third amplification unit 110A2, and the fourth amplification unit 110B2 are assumed to be approximately the same. The optical power P0 is the optical power of the signal light before optical amplification, the optical power P1 is the optical power of the signal light after the first optical amplification, and the optical power P2 is the optical power of the signal light after the second optical amplification.

The demultiplexing unit 111 demultiplexes the S-band signal light from the input unit 101A into the signal light in the short wavelength band and the signal light in the long wavelength band. The demultiplexing unit 111 outputs the demultiplexed signal light in the short wavelength band to the first amplification unit 110A1 and outputs the demultiplexed signal light in the long wavelength band to the third amplification unit 110A2.

The multiplexing unit 112 multiplexes the signal light in the short wavelength band optically amplified by the second amplification unit 110B1 and the signal light in the long wavelength band optically amplified by the fourth amplification unit 110B2. The multiplexing unit 112 outputs the multiplexed signal light in the long wavelength band and signal light in the short wavelength band to the output unit 102A.

The first amplification unit 110A1 optically amplifies the signal light in the short wavelength band of the S-band input from the demultiplexing unit 111, and inputs the signal light in the short wavelength band after the optical amplification to the second amplification unit 110B1. The first amplification unit 110A1 includes a first amplification fiber 103A1, a first pump light source 105A1, and a pump WDM filter 104A1 disposed at the rear stage of the first amplification fiber 103A1. The first amplification fiber 103A1 is, for example, a Raman amplification fiber that, in response to pump light, optically amplifies the signal light in the short wavelength band input from the demultiplexing unit 111. The first pump light source 105A1 is a light source that emits the pump light for exciting the first amplification fiber 103A1. The pump WDM filter 104A1 is a filter that is disposed between the first amplification fiber 103A1 and a second amplification fiber 103B1 and inputs the pump light from the first pump light source 105A1 into the first amplification fiber 103A1.

That is, the first amplification fiber 103A1 optically amplifies the optical power P0 of the signal light in the short wavelength band input from the demultiplexing unit 111 to the optical power P1 of the signal light in the short wavelength band.

The second amplification unit 110B1 optically amplifies the signal light in the short wavelength band of the S-band input from the first amplification unit 110A1, and inputs the signal light in the short wavelength band after the optical amplification to the multiplexing unit 112. The second amplification unit 110B1 includes a second amplification fiber 103B1, a second pump light source 105B1, and a pump WDM filter 104B1 disposed at the rear stage of the second amplification fiber 103B1. The second amplification fiber 103B1 is, for example, a Raman amplification fiber that, in response to pump light, optically amplifies the signal light in the short wavelength band of the S-band input from the first amplification fiber 103A1. The second pump light source 105B1 is a light source that emits the pump light for exciting the second amplification fiber 103B1. The pump WDM filter 104B1 is a filter that is disposed between the second amplification fiber 103B1 and the multiplexing unit 112 and inputs the pump light from the second pump light source 105B1 into the second amplification fiber 103B1.

That is, the second amplification fiber 103B1 optically amplifies the optical power P1 of the signal light in the short wavelength band input from the first amplification fiber 103A1 to the optical power P2 of the signal light in the short wavelength band, and outputs the amplified signal light to the multiplexing unit 112.

The third amplification unit 110A2 optically amplifies the signal light in the long wavelength band of the S-band input from the demultiplexing unit 111, and inputs the signal light in the long wavelength band after the optical amplification to the fourth amplification unit 110B2. The third amplification unit 110A2 includes a first amplification fiber 103A2, a first pump light source 105A2, and a pump WDM filter 104A2 disposed at the rear stage of the first amplification fiber 103A2. The first amplification fiber 103A2 is, for example, a Raman amplification fiber that, in response to pump light, optically amplifies the signal light in the long wavelength band of the S-band input from the demultiplexing unit 111. The first pump light source 105A2 is a light source that emits the pump light for exciting the first amplification fiber 103A2. The pump WDM filter 104A2 is a filter that is disposed between the first amplification fiber 103A2 and a second amplification fiber 103B2 and inputs the pump light from the first pump light source 105A2 into the first amplification fiber 103A2.

That is, the first amplification fiber 103A2 optically amplifies the optical power P0 of the signal light in the long wavelength band input from the demultiplexing unit 111 to the optical power P1 of the signal light in the long wavelength band.

The fourth amplification unit 110B2 optically amplifies the signal light in the long wavelength band of the S-band input from the third amplification unit 110A2, and inputs the signal light in the long wavelength band after the optical amplification to the multiplexing unit 112. The fourth amplification unit 110B2 includes a second amplification fiber 103B2, a second pump light source 105B2, and a pump WDM filter 104B2 disposed at the rear stage of the second amplification fiber 103B2. The second amplification fiber 103B2 is, for example, a Raman amplification fiber that, in response to pump light, optically amplifies the signal light in the long wavelength band of the S-band input from the first amplification fiber 103A2. The second pump light source 105B2 is a light source that emits the pump light for exciting the second amplification fiber 103B2. The pump WDM filter 104B2 is a filter that is disposed between the second amplification fiber 103B2 and the multiplexing unit 112 and inputs the pump light from the second pump light source 105B2 into the second amplification fiber 103B2.

That is, the second amplification fiber 103B2 optically amplifies the optical power P1 of the signal light in the long wavelength band input from the first amplification fiber 103A2 to the optical power P2 of the signal light in the long wavelength band, and outputs the amplified signal light to the multiplexing unit 112.

The first amplification unit 110A1, the second amplification unit 110B1, the third amplification unit 110A2, and the fourth amplification unit 110B2 suppress the occurrence of XPM. The multiplexing unit 112 multiplexes the signal light with the optical power P2 in the short wavelength band from the second amplification unit 110B1 and the signal light with the optical power P2 in the long wavelength band from the fourth amplification unit 110B2, and outputs the multiplexed signal light to the output unit 102A.

In the optical amplifier 100A of the second comparative example, the signal light in the short wavelength band is optically amplified through the first amplification unit 110A1 and the second amplification unit 110B1, and the signal light in the long wavelength band is optically amplified through the third amplification unit 110A2 and the fourth amplification unit 110B2. As a result, the occurrence of XPM can be suppressed and the degradation of nonlinear SNR can be suppressed by optical amplification of the signal light in the short wavelength band and the signal light in the long wavelength band separately.

However, the optical amplifier 100A of the second comparative example requires two amplification units for each wavelength band, resulting in a large number of components. Therefore, there is a need for optical amplifiers that can improve nonlinear SNR by suppressing XPM while suppressing the number of components.

In order to address such situations, embodiments that can improve nonlinear SNR by suppressing XPM are described. The following is a description of an embodiment of an optical communication device and the like of the present invention based on the drawings. Note that the present examples do not limit the disclosed technology. Examples to be described below may be combined as appropriate without inconsistency.

### First Example

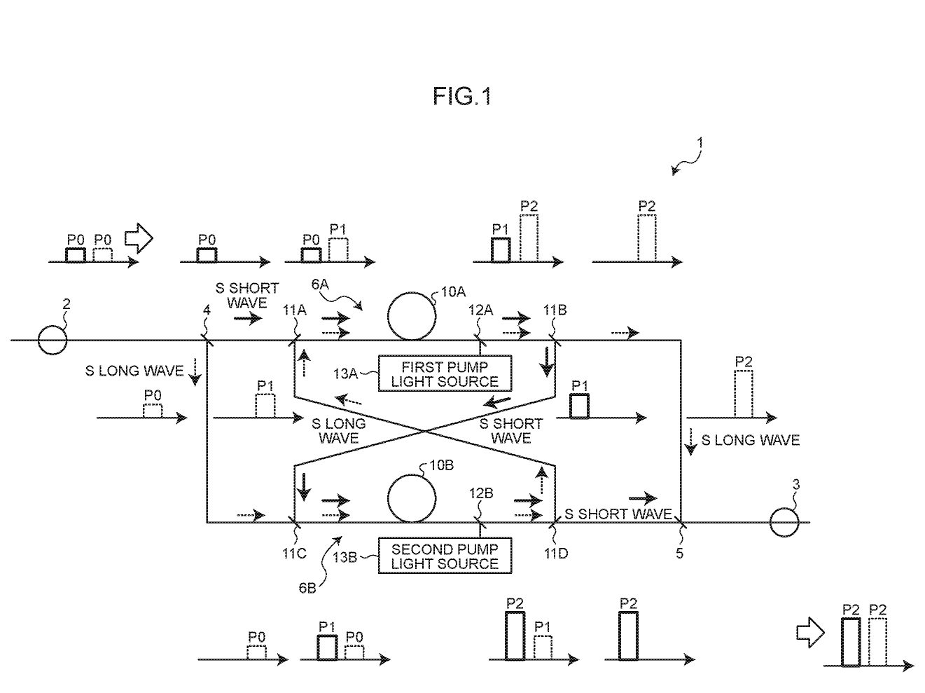

FIG. 1 is an explanatory diagram illustrating an example of an optical amplifier 1 of a first example. The optical amplifier 1 is built into an optical communication device, such as an optical add-drop multiplexer (OADM) node that selectively adds or separates signals of desired wavelengths in a predetermined wavelength band, for example. The optical amplifier 1 illustrated in FIG. 1 includes an input unit 2, an output unit 3, a demultiplexing unit 4, a multiplexing unit 5, a first amplification unit 6A, and a second amplification unit 6B. The input unit 2 is, for example, an input unit of the optical amplifier 1 that optically amplifies S-band signal light. The S-band signal light includes, for example, signal light in the short wavelength band of the S-band and signal light in the long wavelength band of the S-band. The output unit 3 is an output unit of the optical amplifier 1 that optically amplifies the S-band signal light.

The demultiplexing unit 4 demultiplexes the S-band signal light from the input unit 2 into signal light in the short wavelength band and signal light in the long wavelength band. The demultiplexing unit 4 outputs the demultiplexed signal light in the short wavelength band to a first WDM filter 11A in the first amplification unit 6A and outputs the demultiplexed signal light in the long wavelength band to a third WDM filter 11C in the second amplification unit 6B.

The multiplexing unit 5 multiplexes the signal light in the long wavelength band demultiplexed by a second WDM filter 11B in the first amplification unit 6A and the signal light in the short wavelength band demultiplexed by a fourth WDM filter 11D in the second amplification unit 6B. The multiplexing unit 5 outputs the multiplexed signal light in the long wavelength band and signal light in the short wavelength band to the output unit 3.

The first amplification unit 6A optically amplifies the input signal light in the short wavelength band and signal light in the long wavelength band of the S-band. The first amplification unit 6A includes the first WDM filter 11A, a first amplification fiber 10A, a first pump light source 13A, a pump WDM filter 12A disposed at the rear stage of the first amplification fiber 10A, and the second WDM filter 11B.

The second amplification unit 6B optically amplifies the input signal light in the short wavelength band and signal light in the long wavelength band of the S-band. The second amplification unit 6B includes the third WDM filter 11C, a second amplification fiber 10B, a second pump light source 13B, a pump WDM filter 12B disposed at the rear stage of the second amplification fiber 10B, and the fourth WDM filter 11D.

For convenience of explanation, the optical power of signal light passing through the optical amplifier 1 is optically amplified stepwise in the order of P0, P1, and P2, for example. The gain amounts of the first amplification unit 6A and the second amplification unit 6B are assumed to be approximately the same. In FIG. 1, the signal light in the short wavelength band is represented by solid lines and the signal light in the long wavelength band is represented by dotted lines. The optical power P0 is the optical power of the signal light before the first optical amplification. The optical power P1 is the optical power of the signal light after the first optical amplification by the first amplification unit 6A or the second amplification unit 6B. The optical power P2 is the optical power of the signal light after the second optical amplification by the first amplification unit 6A and the second amplification unit 6B.

The first WDM filter 11A is, for example, a first multiplexing unit that multiplexes the signal light in the short wavelength band demultiplexed by the demultiplexing unit 4 and the signal light in the long wavelength band optically amplified by the second amplification fiber 10B and demultiplexed by the fourth WDM filter 11D. The optical power of the signal light in the short wavelength band input to the first WDM filter 11A is P0, and the optical power of the signal light in the long wavelength band input to the first WDM filter 11A is P1. The first WDM filter 11A multiplexes the multiplexed signal light in the short wavelength band and signal light in the long wavelength band, and outputs the multiplexed signal light to the first amplification fiber 10A.

The first amplification fiber 10A is, for example, a Raman amplification fiber that optically amplifies the signal light in the short wavelength band and the signal light in the long wavelength band from the first WDM filter 11A in response to pump light. The first amplification fiber 10A outputs the signal light in the short wavelength band and the signal light in the long wavelength band after the optical amplification to the second WDM filter 11B. The optical power of the signal light in the short wavelength band after the optical amplification output from the first amplification fiber 10A is P1, and the optical power of the signal light in the long wavelength band after the optical amplification output from the first amplification fiber 10A is P2. The first pump light source 13A is a light source that emits the pump light for exciting the first amplification fiber 10A. The pump WDM filter 12A is a WDM filter that is disposed between the first amplification fiber 10A and the second WDM filter 11B and inputs the pump light from the first pump light source 13A into the first amplification fiber 10A.

In the first amplification fiber 10A, as output, the optical power of the signal light in the short wavelength band is P1 because the signal light in the short wavelength band is subjected to the first optical amplification, and the optical power of the signal light in the long wavelength band is P2 because the signal light in the long wavelength band is subjected to the second optical amplification. That is, the total power of the first amplification fiber 10A is smaller as P3 (= P1 + P2) compared to the second amplification fiber 103B in the first comparison example where the optical power of the signal light in the short and long wavelength bands is P2. As a result, the first amplification fiber 10A can suppress XPM.

The second WDM filter 11B is, for example, a first demultiplexing unit that demultiplexes the signal light in the short wavelength band and the signal light in the long wavelength band optically amplified by the first amplification fiber 10A into signal light in the short wavelength band and signal light in the long wavelength band. The second WDM filter 11B outputs the demultiplexed signal light in the long wavelength band to the multiplexing unit 5 and outputs the demultiplexed signal light in the short wavelength band to the third WDM filter 11C. The optical power of the signal light in the short wavelength band demultiplexed by the second WDM filter 11B is P1, and the optical power of the signal light in the long wavelength band demultiplexed by the second WDM filter 11B is P2.

The third WDM filter 11C is, for example, a second multiplexing unit that multiplexes the signal light in the long wavelength band demultiplexed by the demultiplexing unit 4 and the signal light in the short wavelength band optically amplified by the first amplification fiber 10A and demultiplexed by the second WDM filter 11B. The third WDM filter 11C multiplexes the multiplexed signal light in the short wavelength band and signal light in the long wavelength band, and outputs the multiplexed signal light to the second amplification fiber 10B. The optical power of the signal light in the short wavelength band input to the third WDM filter 11C is P1, and the optical power of the signal light in the long wavelength band input to the third WDM filter 11C is P0.

The second amplification fiber 10B is, for example, a Raman amplification fiber that optically amplifies the signal light in the short wavelength band and the signal light in the long wavelength band from the third WDM filter 11C in response to pump light. The second amplification fiber 10B outputs the signal light in the short wavelength band and the signal light in the long wavelength band after the optical amplification to the fourth WDM filter 11D. The optical power of the signal light in the short wavelength band after the optical amplification output from the second amplification fiber 10B is P2, and the optical power of the signal light in the long wavelength band after the optical amplification output from the second amplification fiber 10B is P1. The second pump light source 13B is a light source that emits the pump light for exciting the second amplification fiber 10B. The pump WDM filter 12B is a WDM filter disposed between the second amplification fiber 10B and the fourth WDM filter 11D, and inputs the pump light from the second pump light source 13B into the second amplification fiber 10B.

In the second amplification fiber 10B, as output, the optical power of the signal light in the short wavelength band is P2 because the signal light in the short wavelength band is subjected to the second optical amplification, and the optical power of the signal light in the long wavelength band is P1 because the signal light in the long wavelength band is subjected to the first optical amplification. That is, the total power of the second amplification fiber 10B is smaller as P3 (= P2 + P1) compared to the second amplification fiber 103B in the first comparison example. As a result, the second amplification fiber 10B can suppress XPM.

The fourth WDM filter 11D is, for example, a second demultiplexing unit that demultiplexes the signal light in the short wavelength band and the signal light in the long wavelength band optically amplified by the second amplification fiber 10B into signal light in the short wavelength band and signal light in the long wavelength band. The fourth WDM filter 11D outputs the demultiplexed signal light in the short wavelength band to the multiplexing unit 5 and outputs the demultiplexed signal light in the long wavelength band to the first WDM filter 11A. The optical power of the signal light in the short wavelength band demultiplexed by the fourth WDM filter 11D is P2, and the optical power of the signal light in the long wavelength band demultiplexed by the fourth WDM filter 11D is P1.

The multiplexing unit 5 multiplexes the signal light in the long wavelength band from the second WDM filter 11B and the signal light in the short wavelength band from the fourth WDM filter 11D, and outputs the multiplexed signal light to the output unit 3. The optical power of the signal light in the short wavelength band input to the multiplexing unit 5 is P2, and the optical power of the signal light in the long wavelength band input to the multiplexing unit 5 is P2. As a result, the optical amplifier 1 optically amplifies the signal light in the short wavelength band and the signal light in the long wavelength band with the optical power P2, and outputs the amplified signal light.

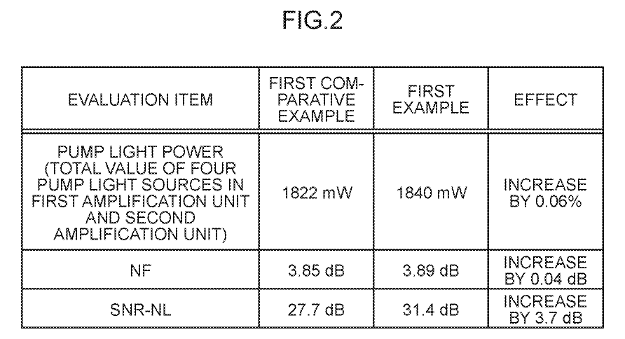

FIG. 2 is an explanatory diagram illustrating an example of simulation results between the optical amplifier 1 of the first example and the optical amplifier 100 of the first comparative example. The wavelengths of the signal light used for the calculation conditions of the simulation were 32 wavelengths in the range of 1489.7 to 1524.9 nm in the S-band, divided into 16 waves from the short wavelength band and 16 waves from the long wavelength band. The signal used for the calculation conditions was 83.67 GBd-16 QAM, and the others were 83.67 GHz dummy light. The first and second amplification fibers, for example, were 1 km DCF, and the pump light used for the first and second amplification fibers were 1396 nm and 1424 nm pump light. Moreover, the amplifier input/output conditions for the optical amplifier 1 were 7 dBm input at the input unit, 24 dBm output at the output unit, and 17 dB gain, for total input/output power of 32 waves.

The nonlinear SNR was used for effect comparison between the average of calculated values at 1497.5 nm, which is centered within 16 wavelengths of the short wavelength band, and the average of calculated values at 1515.6 nm, which is centered within 16 wavelengths of the long wavelength band. In the simulation, the nonlinear SNR related to the output signal of the output unit 3 of the optical amplifier 1 and the nonlinear SNR related to the output signal of the output unit 102 of the optical amplifier 100 were calculated.

As a result, the pump light power as an evaluation item is 1822 mW for the optical amplifier 100 of the first comparative example and 1840 mW for the optical amplifier 1 of the first example as illustrated in FIG. 2, thus increasing by 0.06% compared to the first comparative example. The increase in the pump light power is negligible. The pump light power is the total value of the optical power of two LDs in the first pump light source in the first amplification unit and the optical power of two LDs in the second pump light source in the second amplification unit.

The noise FIGURE(NF) as an evaluation item is 3.85 dB for the optical amplifier 100 of the first comparative example and 3.89 dB for the optical amplifier 1 of the first example as illustrated in FIG. 2, thus increasing by 0.04 dB compared to the first comparative example. The increase in NF is negligible.

The nonlinear SNR as an evaluation item is 27.7 dB for the optical amplifier 100 of the first comparative example and 31.4 dB for the optical amplifier 1 of the first example as illustrated in FIG. 2, thus increasing by 3.7 dB compared to the first comparative example.

That is, in the optical amplifier 100 of the first comparative example, the nonlinear SNR is degraded because the total power of the second amplification fiber 103B is larger, resulting in a larger XPM. On the other hand, in the optical amplifier 1 of the first example, the total power of each of the first amplification fiber 10A and the second amplification fiber 10B is smaller and the XPM is smaller, thus improving the nonlinear SNR. As a result, the nonlinear SNR of the optical amplifier 1 of the first example is significantly improved by 3.7 dB compared to the optical amplifier 100 of the first comparative example.

In the optical amplifier 1 of the first example, the S-band signal light is demultiplexed into signal light in the short wavelength band and signal light in the long wavelength band, and the signal light in the short wavelength band is optically amplified by the first amplification fiber 10A and then is optically amplified by the second amplification fiber 10B. Moreover, in the optical amplifier 1, the signal light in the long wavelength band is optically amplified by the second amplification fiber 10B and then is optically amplified by the first amplification fiber 10A. Subsequently, the optical amplifier 1 multiplexes the signal light in the short wavelength band after two optical amplifications and the signal light in the long wavelength band after two optical amplifications, and outputs the multiplexed signal light. The first amplification fiber 10A has a smaller total power as the optical power P2 of the signal light in the long wavelength band and the optical power P1 of the signal light in the short wavelength band, which can suppress XPM. Moreover, the second amplification fiber 10B has a smaller total power as the optical power P1 of the signal light in the long wavelength band and the optical power P2 of the signal light in the short wavelength band, which can suppress XPM. As a result, the nonlinear SNR can be improved by wavelength division amplification of signal light while suppressing the number of components.

In the optical amplifier 1 of the first example, the case of demultiplexing input S-band signal light into signal light in a short wavelength band and signal light in a long wavelength band is described as an example; however, the present disclosure is not limited to the S-band signal light and for example, the input S-band signal light may be demultiplexed into signal light in the short wavelength band and signal light in the long wavelength band in each band such as L-band, C-band, an U-band and appropriate modifications are possible.

In the optical amplifier 1 of the first example, the case of demultiplexing input signal light into signal light in the short wavelength band and signal light in the long wavelength band is described as an example. However, the input signal light may be demultiplexed into signal light of even-numbered channels (even-numbered ch) and signal light of odd-numbered channels (odd-numbered ch), and the implementation of this method is described below as a second example.

### Second Example

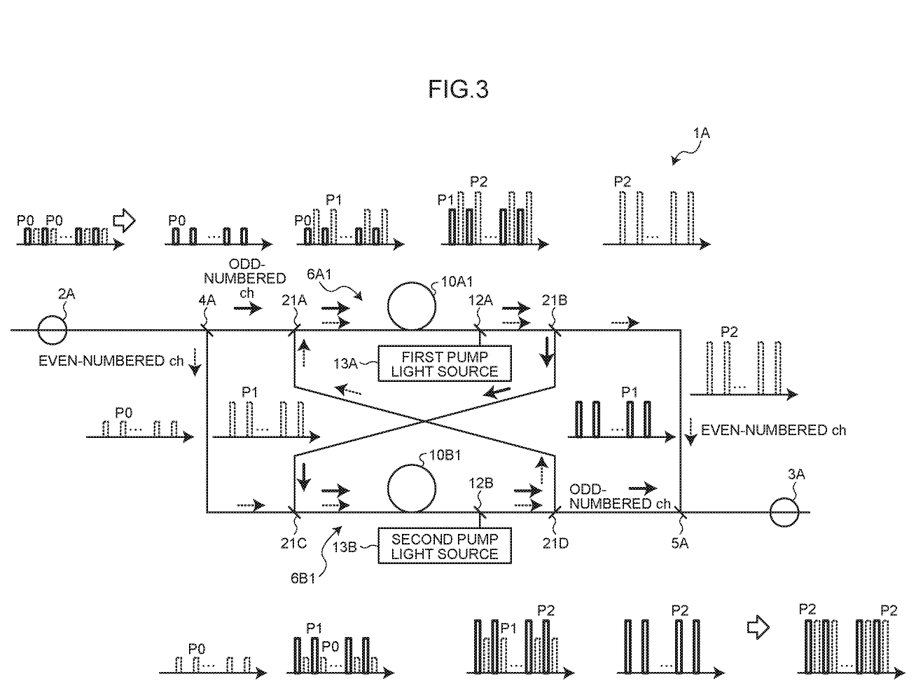

FIG. 3 is an explanatory diagram illustrating an example of an optical amplifier 1A of the second example. The optical amplifier 1A illustrated in FIG. 3 includes an input unit 2A, an output unit 3A, a demultiplexing unit 4A, a multiplexing unit 5A, a first amplification unit 6A1, and a second amplification unit 6B1. The input unit 2A is, for example, an input unit of the optical amplifier 1A that optically amplifies signal light. The signal light includes, for example, signal light of odd-numbered channels and signal light of even-numbered channels. The output unit 3A is an output unit of the optical amplifier 1A that optically amplifies the signal light.

The demultiplexing unit 4A demultiplexes the signal light from the input unit 2A into signal light of odd-numbered channels and signal light of even-numbered channels. The demultiplexing unit 4A outputs the demultiplexed signal light of odd-numbered channels to a first interleaver 21A in the first amplification unit 6A1 and outputs the demultiplexed signal light of even-numbered channels to a third interleaver 21C in the second amplification unit 6B1.

The multiplexing unit 5A multiplexes the signal light of even-numbered channels demultiplexed by a second interleaver 21B in the first amplification unit 6A1 and the signal light of odd-numbered channels demultiplexed by a fourth interleaver 21D in the second amplification unit 6B1. The multiplexing unit 5A outputs the multiplexed signal light of even-numbered channels and signal light of odd-numbered channels to the output unit 3A.

The first amplification unit 6A1 optically amplifies the input signal light of odd-numbered channels and signal light of even-numbered channels. The first amplification unit 6A1 includes the first interleaver 21A, a first amplification fiber 10A1, a first pump light source 13A, a pump WDM filter 12A disposed at the rear stage of the first amplification fiber 10A1, and the second interleaver 21B.

The second amplification unit 6B1 optically amplifies the input signal light of odd-numbered channels and signal light of even-numbered channels. The second amplification unit 6B1 includes the third interleaver 21C, a second amplification fiber 10B1, a second pump light source 13B, a pump WDM filter 12B disposed at the rear stage of the second amplification fiber 10B1, and the fourth interleaver 21D.

For convenience of explanation, the optical power of signal light passing through the optical amplifier 1A is optically amplified stepwise in the order of P0, P1, and P2, for example. The gain amounts of the first amplification unit 6A1 and the second amplification unit 6B1 are assumed to be approximately the same. In FIG. 3, the signal light of odd-numbered channels is represented by solid lines and the signal light of even-numbered channels is represented by dotted lines. The optical power P0 is the optical power of the signal light before optical amplification. The optical power P1 is the optical power of the signal light after the first optical amplification by the first amplification unit 6A1 or the second amplification unit 6B1. The optical power P2 is the optical power of the signal light after the second optical amplification by the first amplification unit 6A1 and the second amplification unit 6B1.

The first interleaver 21A is, for example, an interleaver that multiplexes the signal light of odd-numbered channels demultiplexed by the demultiplexing unit 4 and the signal light of even-numbered channels optically amplified by the second amplification fiber 10B1 and demultiplexed by the fourth interleaver 21D. The optical power of the signal light of odd-numbered channels input to the first interleaver 21A is P0, and the optical power of the signal light of even-numbered channels input to the first interleaver 21A is P1. The first interleaver 21A multiplexes the multiplexed signal light of odd-numbered channels and signal light of even-numbered channels, and outputs the multiplexed signal light to the first amplification fiber 10A1.

The first amplification fiber 10A1 is, for example, a Raman amplification fiber that optically amplifies the signal light of odd-numbered channels and the signal light of even-numbered channels from the first interleaver 21A in response to pump light. The first amplification fiber 10A1 outputs the signal light of odd-numbered channels and the signal light of even-numbered channels after the optical amplification to the second interleaver 21B. The optical power of the signal light of odd-numbered channels after the optical amplification output from the first amplification fiber 10A1 is P1, and the optical power of the signal light of even-numbered channels after the optical amplification output from the first amplification fiber 10A1 is P2. The first pump light source 13A is a light source that emits the pump light for exciting the first amplification fiber 10A1. The pump WDM filter 12A is a WDM filter that is disposed between the first amplification fiber 10A1 and the second interleaver 21B and inputs the pump light from the first pump light source 13A into the first amplification fiber 10A1.

In the first amplification fiber 10A1, as output, the optical power of the signal light of odd-numbered channels is P1 because the signal light of odd-numbered channels is subjected to the first optical amplification, and the signal light of even-numbered channels is P2 because the signal light of even-numbered channels is subjected to the second optical amplification. That is, the total power of the first amplification fiber 10A1 is smaller as P3 (= P1 + P2) compared to the second amplification fiber 103B in the first comparative example. As a result, the first amplification fiber 10A1 can suppress XPM.

The second interleaver 21B is, for example, an interleaver that demultiplexes the signal light of odd-numbered channels and the signal light of even-numbered channels optically amplified by the first amplification fiber 10A1 into signal light of odd-numbered channels and signal light of even-numbered channels. The second interleaver 21B outputs the demultiplexed signal light of even-numbered channels to the multiplexing unit 5A and outputs the demultiplexed signal light of odd-numbered channels to the third interleaver 21C. The optical power of the signal light of odd-numbered channels demultiplexed by the second interleaver 21B is P1, and the optical power of the signal light of even-numbered channels demultiplexed by the second interleaver 21B is P2.

The third interleaver 21C is, for example, an interleaver that multiplexes the signal light of even-numbered channels demultiplexed by the demultiplexing unit 4A and the signal light of odd-numbered channels optically amplified by the first amplification fiber 10A1 and demultiplexed by the second interleaver 21B. The third interleaver 21C multiplexes the multiplexed signal light of odd-numbered channels and signal light of even-numbered channels, and outputs the multiplexed signal light to the second amplification fiber 10B1. The optical power of the signal light of odd-numbered channels input to the third interleaver 21C is P1, and the optical power of the signal light of even-numbered channels input to the third interleaver 21C is P0.

The second amplification fiber 10B1 is, for example, a Raman amplification fiber that optically amplifies the signal light of odd-numbered channels and the signal light of even-numbered channels from the third interleaver 21C in response to pump light. The second amplification fiber 10B1 outputs the signal light of odd-numbered channels and the signal light of even-numbered channels after the optical amplification to the fourth interleaver 21D. The optical power of the signal light of odd-numbered channels after the optical amplification output from the second amplification fiber 10B1 is P2, and the optical power of the signal light of even-numbered channels after the optical amplification output from the second amplification fiber 10B1 is P1. The second pump light source 13B is a light source that emits the pump light for exciting the second amplification fiber 10B1. The pump WDM filter 12B is a WDM filter disposed between the second amplification fiber 10B1 and the fourth interleaver 21D and inputs the pump light from the second pump light source 13B into the second amplification fiber 10B1.

In the second amplification fiber 10B1, as output, the optical power of the signal light of odd-numbered channels is P2 because the signal light of odd-numbered channels is subjected to the second optical amplification, and the optical power of the signal light of even-numbered channels is P1 because the signal light of even-numbered channels is subjected to the first optical amplification. That is, the total power of the second amplification fiber 10B1 is smaller as P3 (= P2 + P1) compared to the second amplification fiber 103B in the first comparative example. As a result, the second amplification fiber 10B1 can suppress XPM.

The fourth interleaver 21D is, for example, an interleaver that demultiplexes the signal light of odd-numbered channels and the signal light of even-numbered channels optically amplified by the second amplification fiber 10B1 into signal light of odd-numbered channels and signal light of even-numbered channels. The fourth interleaver 21D outputs the demultiplexed signal light of odd-numbered channels to the multiplexing unit 5A and outputs the demultiplexed signal light of even-numbered channels to the first interleaver 21A. The optical power of the signal light of odd-numbered channels demultiplexed by the fourth interleaver 21D is P2, and the optical power of the signal light of even-numbered channels demultiplexed by the fourth interleaver 21D is P1.

The multiplexing unit 5A multiplexes the signal light of even-numbered channels from the second interleaver 21B and the signal light of odd-numbered channels from the fourth interleaver 21D, and outputs the multiplexed signal light to the output unit 3A. The optical power of the signal light of odd-numbered channels input to the multiplexing unit 5A is P2, and the optical power of the signal light of even-numbered channels input to the multiplexing unit 5A is P2. As a result, the optical amplifier 1A optically amplifies the signal light of odd-numbered channels and the signal light of even-numbered channels with the optical power P2, and outputs the amplified signal light.

In the optical amplifier 1A of the second example, signal light is demultiplexed into signal light of odd-numbered channels and signal light of even-numbered channels, and the signal light of odd-numbered channels is optically amplified by the first amplification fiber 10A1 and then is optically amplified by the second amplification fiber 10B1. Moreover, in the optical amplifier 1A, the signal light of even-numbered channels is optically amplified by the second amplification fiber 10B1 and then is optically amplified by the first amplification fiber 10A1. Subsequently, the optical amplifier 1A multiplexes the signal light of odd-numbered channels after two optical amplifications and the signal light of even-numbered channels after two optical amplifications, and outputs the multiplexed signal light. The first amplification fiber 10A1 has a smaller total power as the optical power P2 of the signal light of even-numbered channels and the optical power P1 of the signal light of odd-numbered channels, thereby suppressing XPM. Moreover, the second amplification fiber 10B1 has a smaller total power as the optical power P1 of the signal light of even-numbered channels and the optical power P2 of the signal light of odd-numbered channels, which can suppress XPM. As a result, the nonlinear SNR can be improved by wavelength division amplification of signal light while suppressing the number of components.

In the optical amplifier 1 of the first example, the case of demultiplexing input signal light into signal light in a short wavelength band and signal light in a long wavelength band is described as an example. However, the input signal light may be demultiplexed into signal light of X-polarization and signal light of Y-polarization, and the implementation of this method is described below as a third example.

### Third Example

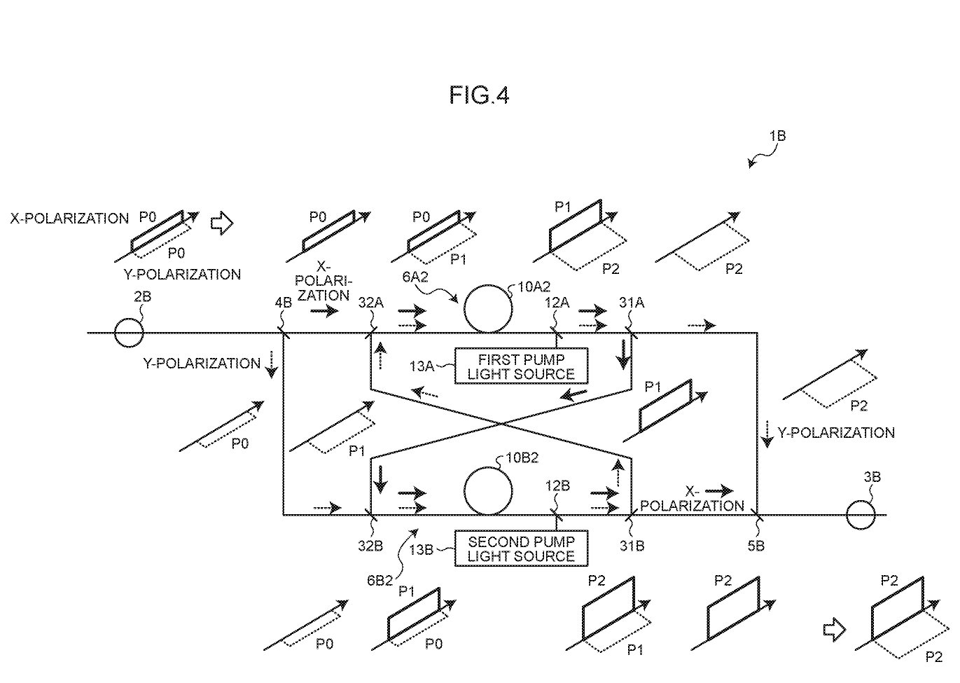

FIG. 4 is an explanatory diagram illustrating an example of an optical amplifier 1B of the third example. The optical amplifier 1B illustrated in FIG. 4 includes an input unit 2B, an output unit 3B, a demultiplexing unit 4B, a multiplexing unit 5B, a first amplification unit 6A2, and a second amplification unit 6B2. The input unit 2B is, for example, an input unit of the optical amplifier 1B that optically amplifies signal light. The signal light includes, for example, signal light of X-polarization and signal light of Y-polarization. The output unit 3B is an output unit of the optical amplifier 1B that optically amplifies the signal light.

The demultiplexing unit 4B is, for example, a polarizing beam splitter (PBS) that demultiplexes the signal light from the input unit 2B into signal light of X-polarization and signal light of Y-polarization. The demultiplexing unit 4B outputs the demultiplexed signal light of X-polarization to a first polarization beam combiner (PBC) 32A in the first amplification unit 6A2, and outputs the demultiplexed signal light of Y-polarization to a second PBC 32B in the second amplification unit 6B2.

The multiplexing unit 5B is, for example, a PBC that multiplexes the signal light of Y-polarization demultiplexed by a first PBS 31A in the first amplification unit 6A2 and the signal light of X-polarization demultiplexed by a second PBS 31B in the second amplification unit 6B2. The multiplexing unit 5B outputs the multiplexed signal light of Y-polarization and signal light of X-polarization to the output unit 3B.

The first amplification unit 6A2 optically amplifies the input signal light of X-polarization and signal light of Y-polarization. The first amplification unit 6A2 includes the first PBC 32A, a first amplification fiber 10A2, a first pump light source 13A, a pump WDM filter 12A disposed at the rear stage of the first amplification fiber 10A2, and the first PBS 31A.

The second amplification unit 6B2 optically amplifies the input signal light of X-polarization and signal light of Y-polarization. The second amplification unit 6B2 includes the second PBC 32B, a second amplification fiber 10B2, a second pump light source 13B, a pump WDM filter 12B disposed at the rear stage of the second amplification fiber 10B2, and the second PBS 31B.

For convenience of explanation, the optical power of the signal light passing through the optical amplifier 1B is optically amplified stepwise in the order of P0, P1, and P2, for example. The gain amounts of the first amplification unit 6A2 and the second amplification unit 6B2 are assumed to be approximately the same. In FIG. 1, the signal light of X-polarization is represented by solid lines and the signal light of Y-polarization is represented by dotted lines. The optical power P0 is the optical power of the signal light before the first optical amplification. The optical power P1 is the optical power of the signal light after the first optical amplification by the first amplification unit 6A2 or the second amplification unit 6B2. The optical power P2 is the optical power of the signal light after the second optical amplification by the first amplification unit 6A2 or the second amplification unit 6B2.

The first PBC 32A is, for example, a PBC that multiplexes the signal light of X-polarization demultiplexed by the demultiplexing unit 4B and the signal light of Y-polarization optically amplified by the second amplification fiber 10B2 and demultiplexed by the second PBS 31B. The first PBC 32A multiplexes the multiplexed signal light of X-polarization and signal light of Y-polarization, and outputs the multiplexed signal light to the first amplification fiber 10A2. The optical power of the signal light of X-polarization input to the first PBC 32A is P0 and the optical power of the signal light of Y-polarization input to the first PBC 32A is P1.

The first amplification fiber 10A2 is, for example, a Raman amplification fiber that optically amplifies the signal light of X-polarization and the signal light of Y-polarization from the first PBC 32A in response to pump light. The first amplification fiber 10A2 outputs the signal light of X-polarization and the signal light of Y-polarization after the optical amplification to the first PBS 31A. The optical power of the signal light of X-polarization after the optical amplification output from the first amplification fiber 10A is P1, and the optical power of the signal light of Y-polarization after the optical amplification output from the first amplification fiber 10A is P2. The first pump light source 13A is a light source that emits the pump light for exciting the first amplification fiber 10A2. The pump WDM filter 12A is a WDM filter that is disposed between the first amplification fiber 10A2 and the first PBS 31A and inputs the pump light from the first pump light source 13A into the first amplification fiber 10A2.

In the first amplification fiber 10A2, as output, the optical power of the signal light of X-polarization is P1 because the signal light of X-polarization is subjected to the first optical amplification, and the optical power of the signal light of Y-polarization is P2 because the signal light of Y-polarization is subjected to the second optical amplification. That is, the total power of the first amplification fiber 10A2 is smaller as P3 (= P1 + P2) compared to the second amplification fiber 103B in the first comparative example. As a result, the first amplification fiber 10A2 can suppress XPM.

The first PBS 31A is, for example, a PBS that demultiplexes the signal light of X-polarization and the signal light of Y-polarization optically amplified by the first amplification fiber 10A2 into signal light of X-polarization and signal light of Y-polarization. The first PBS 31A outputs the demultiplexed signal light of Y-polarization to the multiplexing unit 5B and outputs the demultiplexed signal light of X-polarization to the second PBC 32B. The optical power of the signal light of X-polarization demultiplexed by the first PBS 31A is P1, and the optical power of the signal light of Y-polarization demultiplexed by the first PBS 31A is P2.

The second PBC 32B is, for example, a PBC that multiplexes the signal light of Y-polarization demultiplexed by the demultiplexing unit 4B and the signal light of X-polarization optically amplified by the first amplification fiber 10A2 and demultiplexed by the first PBS 31A. The second PBC 32B multiplexes the multiplexed signal light of X-polarization and signal light of Y-polarization, and outputs the multiplexed signal light to the second amplification fiber 10B2. The optical power of the signal light of X-polarization input to the second PBC 32B is P1 and the optical power of the signal light of Y-polarization input to the second PBC 32B is P0.

The second amplification fiber 10B2 is, for example, a Raman amplification fiber that optically amplifies the signal light of X-polarization and the signal light of Y-polarization from the second PBC 32B in response to pump light. The second amplification fiber 10B2 outputs the signal light of X-polarization and signal light of Y-polarization after the optical amplification to the second PBS 31B. The optical power of the signal light of X-polarization after the optical amplification output from the second amplification fiber 10B2 is P2, and the optical power of the signal light of Y-polarization after the optical amplification output from the second amplification fiber 10B2 is P1. The second pump light source 13B is a light source that emits the pump light for exciting the second amplification fiber 10B2. The pump WDM filter 12B is a WDM filter disposed between the second amplification fiber 10B2 and the second PBS 31B, and inputs the pump light from the second pump light source 13B into the second amplification fiber 10B2.

In the second amplification fiber 10B2, as output, the optical power of the signal light of X-polarization is P2 because the signal light of X-polarization is subjected to the second optical amplification, and the optical power of the signal light of Y-polarization is P1 because the signal light of Y-polarization is subjected to the first optical amplification. That is, the total power of the second amplification fiber 10B2 is smaller as P3 (= P2 + P1) compared to the second amplification fiber 103B in the first comparative example. As a result, the second amplification fiber 10B2 can suppress XPM.

The second PBS 31B is, for example, a PBS that demultiplexes the signal light of X-polarization and the signal light of Y-polarization optically amplified by the second amplification fiber 10B2 into signal light of X-polarization and signal light of Y-polarization. The second PBS 31B outputs the demultiplexed signal light of X-polarization to the multiplexing unit 5B and outputs the demultiplexed signal light of Y-polarization to the first PBC 32A. The optical power of the signal light of X-polarization demultiplexed by the second PBS 31B is P2, and the optical power of the signal light of Y-polarization demultiplexed by the second PBS 31B is P1.

The multiplexing unit 5B multiplexes the signal light of Y-polarization from the first PBS 31A and the signal light of X-polarization from the second PBS 31B, and outputs the multiplexed signal light to the output unit 3B. The optical power of the signal light of X-polarization input to the multiplexing unit 5B is P2 and the optical power of the signal light of Y-polarization input to the multiplexing unit 5B is P2. As a result, the optical amplifier 1B optically amplifies the signal light of X-polarization and the signal light of Y-polarization with the optical power P2, and outputs the amplified signal light.

In the optical amplifier 1B of the third example, signal light is demultiplexed into signal light of X-polarization and signal light of Y-polarization, and the signal light of X-polarization is optically amplified by the first amplification fiber 10A2 and then is optically amplified by the second amplification fiber 10B2. Moreover, in the optical amplifier 1B, the signal light of Y-polarization is optically amplified by the second amplification fiber 10B2 and then is optically amplified by the first amplification fiber 10A2. Subsequently, the optical amplifier 1B multiplexes the signal light of X-polarization after two optical amplifications and the signal light of Y-polarization after two optical amplifications, and outputs the multiplexed signal light. The first amplification fiber 10A2 has a smaller total power as the optical power P2 of the signal light of Y-polarization and the optical power P1 of the signal light of X-polarization, which can suppress XPM. Moreover, the second amplification fiber 10B2 has a smaller total power as the optical power P1 of the signal light of Y-polarization and the optical power P2 of the signal light of X-polarization, which can suppress XPM. As a result, the nonlinear SNR can be improved by wavelength division amplification of signal light while suppressing the number of components.

In the optical amplifier 1 of the first example, the case of using a unidirectional amplification fiber as the first amplification fiber 10A and the second amplification fiber 10B is described as an example. However, a bidirectional amplification fiber may be used as the first amplification fiber 10A and the second amplification fiber 10B, and the implementation of this method is described below as a fourth example.

### Fourth Example

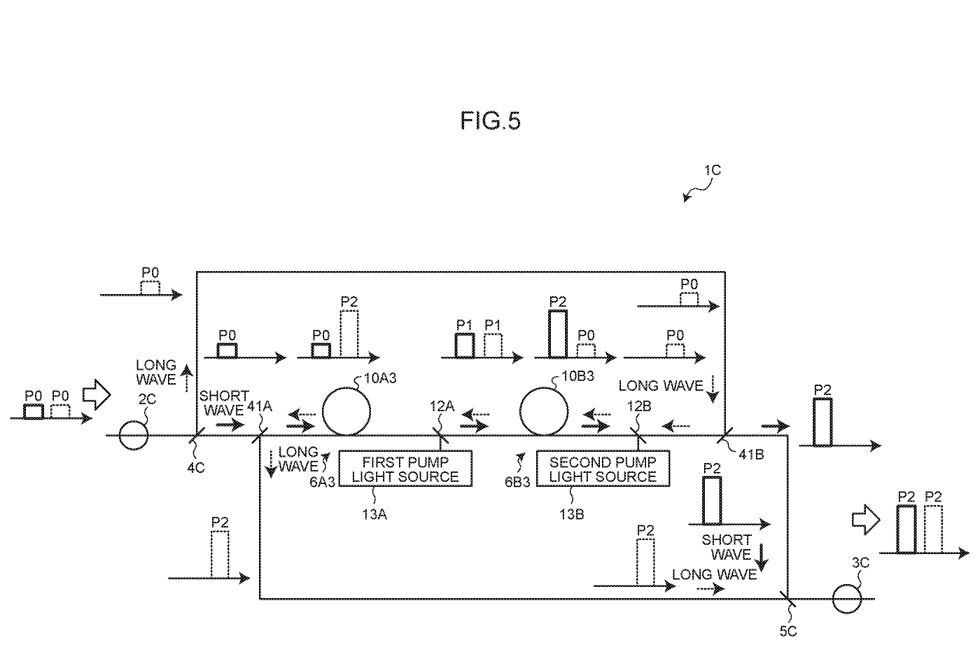

FIG. 5 is an explanatory diagram illustrating an example of an optical amplifier 1C of the fourth example. The optical amplifier 1C illustrated in FIG. 5 includes an input unit 2C, an output unit 3C, a demultiplexing unit 4C, a multiplexing unit 5C, a first amplification unit 6A3, and a second amplification unit 6B3. The input unit 2C is, for example, an input unit of the optical amplifier 1C that optically amplifies S-band signal light. The S-band signal light includes, for example, signal light in the short wavelength band of the S-band and signal light in the long wavelength band of the S-band. The output unit 3C is an output unit of the optical amplifier 1C that optically amplifies the S-band signal light.

The demultiplexing unit 4C demultiplexes the S-band signal light from the input unit 2C into the signal light in the short wavelength band and the signal light in the long wavelength band. The demultiplexing unit 4C outputs the demultiplexed signal light in the short wavelength band to a first WDM filter 41A in the first amplification unit 6A3 and the demultiplexed signal light in the long wavelength band to a second WDM filter 41B in the second amplification unit 6B3.

The multiplexing unit 5C multiplexes the signal light in the long wavelength band demultiplexed by the first WDM filter 41A and the signal light in the short wavelength band demultiplexed by the second WDM filter 41B, and outputs the multiplexed signal light in the long wavelength band and signal light in the short wavelength band to the output unit 3C.

The first amplification unit 6A3 is a bidirectional amplification unit that, in response to pump light, optically amplifies the signal light in the short wavelength band input from a forward direction and optically amplifies the signal light in the long wavelength band input from a reverse direction. The first amplification unit 6A3 includes the first WDM filter 41A, a first amplification fiber 10A3, a first pump light source 13A, and a pump WDM filter 12A disposed at the rear stage of the first amplification fiber 10A3.

The second amplification unit 6B3 is a bidirectional amplification unit that, in response to pump light, optically amplifies the signal light in the short wavelength band input from the forward direction and optically amplifies the signal light in the long wavelength band input from the reverse direction. The second amplification unit 6B3 includes the second WDM filter 41B, a second amplification fiber 10B3, a second pump light source 13B, and a pump WDM filter 12B disposed at the rear stage of the second amplification fiber 10B3.

For convenience of explanation, the optical power of the signal light passing through the optical amplifier 1C is optically amplified stepwise in the order of P0, P1, and P2, for example. The gain amounts of the first amplification unit 6A3 and the second amplification unit 6B3 are assumed to be approximately the same. In FIG. 5, the signal light in the short wavelength band is represented by solid lines and the signal light in the long wavelength band is represented by dotted lines. The optical power P0 is the optical power of the signal light before the first optical amplification. The optical power P1 is the optical power of the signal light after the first optical amplification by the first amplification unit 6A3 or the second amplification unit 6B3. The optical power P2 is the optical power of the signal light after the second optical amplification by the first amplification unit 6A3 and the second amplification unit 6B3.

The first WDM filter 41A is, for example, a first multiplexing unit that outputs the signal light in the short wavelength band demultiplexed by the demultiplexing unit 4C to the first amplification fiber 10A3 and outputs the signal light in the long wavelength band optically amplified by the first amplification fiber 10A3 to the multiplexing unit 5C. The optical power of the signal light in the short wavelength band input to the first WDM filter 41A is P0, and the optical power of the signal light in the long wavelength band input to the first WDM filter 41A is P2.

The first amplification fiber 10A3 optically amplifies the signal light in the short wavelength band from the first WDM filter 41A, and outputs the signal light in the short wavelength band after the optical amplification to the second amplification fiber 10B3. The optical power of the signal light in the short wavelength band after the optical amplification output from the first amplification fiber 10A3 is P1. The first amplification fiber 10A3 optically amplifies the signal light in the long wavelength band from the second amplification fiber 10B3, and outputs the signal light in the long wavelength band after the optical amplification to the first WDM filter 41A. The optical power of the signal light in the long wavelength band after the optical amplification output from the first amplification fiber 10A3 is P2. The first amplification fiber 10A3 is, for example, a bidirectional Raman amplification fiber. The first pump light source 13A is a light source that emits pump light for exciting the first amplification fiber 10A3. The pump WDM filter 12A is a WDM filter that is disposed between the first amplification fiber 10A3 and the second amplification fiber 10B3 and inputs the pump light from the first pump light source 13A into the first amplification fiber 10A3.

In the first amplification fiber 10A3, as output, the optical power of the signal light in the short wavelength band is P1 because the signal light in the short wavelength band is subjected to the first optical amplification, and the optical power of the signal light in the long wavelength band is P2 because the signal light in the long wavelength band is subjected to the second optical amplification. That is, the total power of the first amplification fiber 10A3 is smaller as P3 (= P1 + P2) compared to the second amplification fiber 103B in the first comparative example. As a result, the first amplification fiber 10A3 can suppress XPM.

The second WDM filter 41B is, for example, a first demultiplexing unit that outputs the signal light in the long wavelength band demultiplexed by the demultiplexing unit 4C to the second amplification fiber 10B3 and outputs the signal light in the short wavelength band optically amplified by the second amplification fiber 10B3 to the multiplexing unit 5C. The optical power of the signal light in the short wavelength band input to the second WDM filter 41B is P2, and the optical power of the signal light in the long wavelength band input to the second WDM filter 41B is P0.

The second amplification fiber 10B3 optically amplifies the signal light in the long wavelength band from the second WDM filter 41B, and outputs the signal light in the long wavelength band after the optical amplification to the first amplification fiber 10A3. The optical power of the signal light in the long wavelength band after the optical amplification output from the second amplification fiber 10B3 is P1. The second amplification fiber 10B3 optically amplifies the signal light in the short wavelength band from the first amplification fiber 10A3, and outputs the signal light in the short wavelength band after the optical amplification to the second WDM filter 41B. The optical power of the signal light in the short wavelength band after the optical amplification output from the second amplification fiber 10B3 is P2. The second amplification fiber 10B3 is, for example, a bidirectional Raman amplification fiber. The second pump light source 13B is a light source that emits pump light for exciting the second amplification fiber 10B3. The pump WDM filter 12B is a WDM filter that is disposed between the second amplification fiber 10B3 and the second WDM filter 41B and inputs the pump light from the second pump light source 13B into the second amplification fiber 10B3.

In the second amplification fiber 10B3, as output, the optical power of the signal light in the short wavelength band is P2 because the signal light in the short wavelength band is subjected to the second optical amplification, and the optical power of the signal light in the long wavelength band is P1 because the signal light in the long wavelength band is subjected to the first optical amplification. That is, the total power of the second amplification fiber 10B3 is smaller as P3 (= P2 + P1) compared to the second amplification fiber 103B in the first comparative example. As a result, the second amplification fiber 10B3 can suppress XPM.

The multiplexing unit 5C multiplexes the signal light in the long wavelength band from the first WDM filter 41A and the signal light in the short wavelength band from the second WDM filter 41B, and outputs the multiplexed signal light to the output unit 3C. The optical power of the signal light in the short wavelength band input to the multiplexing unit 5C is P2 and the optical power of the signal light in the long wavelength band input to the multiplexing unit 5C is P2. As a result, the optical amplifier 1C optically amplifies the signal light in the short wavelength band and the signal light in the long wavelength band with the optical power P2, and outputs the amplified signal light.

In the optical amplifier 1C of the fourth example, S-band signal light is demultiplexed into signal light in a short wavelength band and signal light in a long wavelength band, and the signal light in the short wavelength band is input to the bidirectional first amplification fiber 10A3, and the signal light in the long wavelength band is input to the bidirectional second amplification fiber 10B3. In the optical amplifier 1C, the signal light in the short wavelength band is optically amplified by the first amplification fiber 10A3 and then is optically amplified by the second amplification fiber 10B3. Moreover, in the optical amplifier 1C, the signal light in the long wavelength band is optically amplified by the second amplification fiber 10B3 and then is optically amplified by the first amplification fiber 10A3. Subsequently, the optical amplifier 1C multiplexes the signal light in the short wavelength band after two optical amplifications and the signal light in the long wavelength band after two optical amplifications, and outputs the multiplexed signal light. The first amplification fiber 10A3 has a smaller total power as the optical power P2 of the signal light in the long wavelength band and the optical power P1 of the signal light in the short wavelength band, which can suppress XPM. Moreover, the second amplification fiber 10B3 has a smaller total power as the optical power P1 of the signal light in the long wavelength band and the optical power P2 of the signal light in the short wavelength band, which can suppress XPM. As a result, the nonlinear SNR can be improved by wavelength division amplification of signal light while suppressing the number of components.

In the optical amplifier 1 of the first example, the case of demultiplexing signal light into signal light in a short wavelength band and signal light in a long wavelength band is described as an example; however, the signal light may be demultiplexed into signal light in four wavelength bands, and the implementation of this method is described below as a fifth example.

### Fifth Example

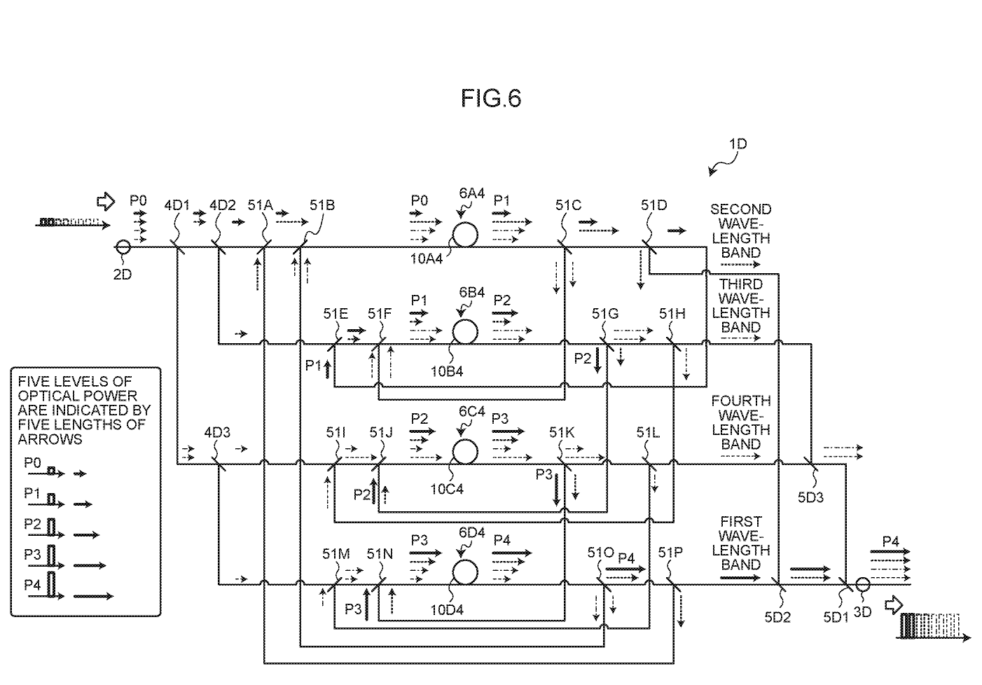

FIG. 6 is an explanatory diagram illustrating an example of an optical amplifier 1D of the fifth example. The optical amplifier 1D illustrated in FIG. 6 includes an input unit 2D, an output unit 3D, a first demultiplexing unit 4D1, a second demultiplexing unit 4D2, a third demultiplexing unit 4D3, a first multiplexing unit 5D1, a second multiplexing unit 5D2, and a third multiplexing unit 5D3. The optical amplifier 1D includes a first amplification unit 6A4, a second amplification unit 6B4, a third amplification unit 6C4, and a fourth amplification unit 6D4. The input unit 2D is, for example, an input unit of the optical amplifier 1D that optically amplifies signal light. The signal light includes, for example, signal light in a first wavelength band, signal light in a second wavelength band, signal light in a third wavelength band, and signal light in a fourth wavelength band. The output unit 3D is an output unit of the optical amplifier 1D that optically amplifies the signal light.

The first demultiplexing unit 4D1 demultiplexes the signal light from the input unit 2D into the signal light in the first wavelength band, the signal light in the second wavelength band, the signal light in the third wavelength band, and the signal light in the fourth wavelength band. The first demultiplexing unit 4D1 outputs the demultiplexed signal light in the first and second wavelength bands to the second demultiplexing unit 4D2, and outputs the demultiplexed signal light in the third and fourth wavelength bands to the third demultiplexing unit 4D3.

The second multiplexing unit 5D2 multiplexes the signal light in the first wavelength band and the signal light in the second wavelength band, and outputs the multiplexed signal light in the first and second wavelength bands to the first multiplexing unit 5D1. The third multiplexing unit 5D3 multiplexes the signal light in the third wavelength band and the signal light in the fourth wavelength band, and outputs the multiplexed signal light in the third and fourth wavelength bands to the first multiplexing unit 5D1. The first multiplexing unit 5D1 multiplexes the signal light in the first and second wavelength bands from the second multiplexing unit 5D2 and the signal light in the third and fourth wavelength bands from the third multiplexing unit 5D3, and outputs the multiplexed signal light to the output unit 3D.

The first amplification unit 6A4 optically amplifies the input signal light in the first to fourth wavelength bands, and outputs the signal light in the second wavelength band to the second multiplexing unit 5D2. The first amplification unit 6A4 includes a first WDM filter 51A, a second WDM filter 51B, a first amplification fiber 10A4, a third WDM filter 51C, and a fourth WDM filter 51D. For convenience of explanation, components such as the pump light source that inputs pump light to the first amplification fiber 10A4 are omitted.

The second amplification unit 6B4 optically amplifies the input signal light in the first to fourth wavelength bands, and outputs the signal light in the third wavelength band to the third multiplexing unit 5D3. The second amplification unit 6B4 includes a fifth WDM filter 51E, a sixth WDM filter 51F, a second amplification fiber 10B4, a seventh WDM filter 51G, and an eighth WDM filter 51H.

The third amplification unit 6C4 optically amplifies the input signal light in the first to fourth wavelength bands, and outputs the signal light in the fourth wavelength band to the third multiplexing unit 5D3. The third amplification unit 6C4 includes a ninth WDM filter 51I, a tenth WDM filter 51J, a third amplification fiber 10C4, an eleventh WDM filter 51K, and a twelfth WDM filter 51L.

The fourth amplification unit 6D4 optically amplifies the input signal light in the first to fourth wavelength bands, and outputs the signal light in the first wavelength band to the second multiplexing unit 5D2. The fourth amplification unit 6D4 includes a thirteenth WDM filter 51M, a fourteenth WDM filter 51N, a fourth amplification fiber 10D4, a fifteenth WDM filter 51O, and a sixteenth WDM filter 51P.

For convenience of explanation, the optical power of the signal light passing through the optical amplifier 1D is optically amplified stepwise in the order of P0, P1, P2, P3, and P4, for example. The gain amounts of the first amplification unit 6A4, the second amplification unit 6B4, the third amplification unit 6C4, and the fourth amplification unit 6D4 are assumed to be approximately the same. The optical power P0 is the optical power of the signal light before the first optical amplification by the first amplification unit 6A4, the second amplification unit 6B, the third amplification unit 6C4, or the fourth amplification unit 6D4. The optical power P1 is the optical power of the signal light after the first optical amplification by the first amplification unit 6A4, the second amplification unit 6B4, the third amplification unit 6C4, or the fourth amplification unit 6D4. The optical power P2 is the optical power of the signal light after the second optical amplification, the optical power P3 is the optical power of the signal light after the third optical amplification, and the optical power P4 is the optical power of the signal light after the fourth optical amplification.

The first WDM filter 51A in the first amplification unit 6A4 multiplexes the signal light in the first wavelength band demultiplexed by the second demultiplexing unit 4D2 and the signal light in the second wavelength band optically amplified by the fourth amplification fiber 10D4 and demultiplexed by the sixteenth WDM filter 51P. The first WDM filter 51A multiplexes the multiplexed signal light in the first wavelength band and signal light in the second wavelength band, and outputs the multiplexed signal light to the second WDM filter 51B. The optical power of the signal light in the first wavelength band input to the first WDM filter 51A is P0, and the optical power of the signal light in the second wavelength band input to the first WDM filter 51A is P3.

The second WDM filter 51B multiplexes the signal light in the first and second wavelength bands from the first WDM filter 51A and the signal light in the third and fourth wavelength bands optically amplified by the fourth amplification fiber 10D4 and demultiplexed by the fifteenth WDM filter 51O. The second WDM filter 51B multiplexes the signal light in the first and second wavelength bands and the signal light in the third and fourth wavelength bands, and outputs the multiplexed signal light to the first amplification fiber 10A4. The optical power of the signal light in the first wavelength band input to the second WDM filter 51B is P0, the optical power of the signal light in the second wavelength band input to the second WDM filter 51B is P3, the optical power of the signal light in the third wavelength band input to the second WDM filter 51B is P2, and the optical power of the signal light in the fourth wavelength band input to the second WDM filter 51B is P1.

The first amplification fiber 10A4 is, for example, a Raman amplification fiber that optically amplifies the signal light in the first to fourth wavelength bands from the second WDM filter 51B and outputs the signal light in the first to fourth wavelength bands after the optical amplification to the third WDM filter 51C. The optical power of the signal light in the first wavelength band output from the first amplification fiber 10A4 is P1, the optical power of the signal light in the second wavelength band output from the first amplification fiber 10A4 is P4, the optical power of the signal light in the third wavelength band output from the first amplification fiber 10A4 is P3, and the optical power of the signal light in the fourth wavelength band output from the first amplification fiber 10A4 is P2.

In the first amplification fiber 10A4, as output, the optical power of the signal light in the first wavelength band is P1, the optical power of the signal light in the second wavelength band is P4, the optical power of the signal light in the third wavelength band is P3, and the optical power of the signal light in the fourth wavelength band is P2. That is, the total power of the first amplification fiber 10A4 is smaller as P10 (= P1 + P2 + P3 + P4) compared to when all wavelength bands are P4. As a result, the first amplification fiber 10A4 can suppress XPM.

The third WDM filter 51C demultiplexes the signal light in the first to fourth wavelength bands optically amplified by the first amplification fiber 10A4 into signal light in the first and second wavelength bands and signal light in the third and fourth wavelength bands. The third WDM filter 51C outputs the demultiplexed signal light in the first and second wavelength bands to the fourth WDM filter 51D, and outputs the demultiplexed signal light in the third and fourth wavelength bands to the sixth WDM filter 51F in the second amplification unit 6B4. The optical power of the signal light in the first wavelength band input to the third WDM filter 51C is P1, the optical power of the signal light in the second wavelength band input to the third WDM filter 51C is P4, the optical power of the signal light in the third wavelength band input to the third WDM filter 51C is P3, and the optical power of the signal light in the fourth wavelength band input to the third WDM filter 51C is P2.

The fourth WDM filter 51D demultiplexes the signal light in the first and second wavelength bands from the third WDM filter 51C into signal light in the first wavelength band and signal light in the second wavelength band. The fourth WDM filter 51D outputs the demultiplexed signal light in the first wavelength band to the fifth WDM filter 51E, and outputs the demultiplexed signal light in the second wavelength band to the second multiplexing unit 5D2. The optical power of the signal light in the first wavelength band input to the fourth WDM filter 51D is P1, and the optical power of the signal light in the second wavelength band input to the fourth WDM filter 51D is P4.

The fifth WDM filter 51E in the second amplification unit 6B4 multiplexes the signal light in the second wavelength band demultiplexed by the second demultiplexing unit 4D2 and the signal light in the first wavelength band optically amplified by the first amplification fiber 10A4 and demultiplexed by the fourth WDM filter 51D. The fifth WDM filter 51E multiplexes the multiplexed signal light in the first wavelength band and signal light in the second wavelength band, and outputs the multiplexed signal light to the sixth WDM filter 51F. The optical power of the signal light in the second wavelength band input to the fifth WDM filter 51E is P0, and the optical power of the signal light in the first wavelength band input to the fifth WDM filter 51E is P1.

The sixth WDM filter 51F multiplexes the signal light in the first and second wavelength bands from the fifth WDM filter 51E and the signal light in the third and fourth wavelength bands optically amplified by the first amplification fiber 10A and demultiplexed by the third WDM filter 51C. The sixth WDM filter 51F multiplexes the signal light in the first and second wavelength bands and the signal light in the third and fourth wavelength bands, and outputs the multiplexed signal light to the second amplification fiber 10B4. The optical power of the signal light in the second wavelength band input to the sixth WDM filter 51F is P0, the optical power of the signal light in the first wavelength band input to the sixth WDM filter 51F is P1, the optical power of the signal light in the third wavelength band input to the sixth WDM filter 51F is P3, and the optical power of the signal light in the fourth wavelength band input to the sixth WDM filter 51F is P2.

The second amplification fiber 10B4 is, for example, a Raman amplification fiber that optically amplifies the signal light in the first to fourth wavelength bands from the sixth WDM filter 51F and outputs the signal light in the first to fourth wavelength bands after the optical amplification to the seventh WDM filter 51G. The optical power of the signal light in the first wavelength band output from the second amplification fiber 10B4 is P2, the optical power of the signal light in the second wavelength band output from the second amplification fiber 10B4 is P1, the optical power of the signal light in the third wavelength band output from the second amplification fiber 10B4 is P4, and the optical power of the signal light in the fourth wavelength band output from the second amplification fiber 10B4 is P3.

In the second amplification fiber 10B4, as output, the optical power of the signal light in the first wavelength band is P2, the optical power of the signal light in the second wavelength band is P1, the optical power of the signal light in the third wavelength band is P4, and the optical power of the signal light in the fourth wavelength band is P3. That is, the total power of the second amplification fiber 10B4 is smaller as P10 (= P1 + P2 + P3 + P4) compared to when all wavelength bands are P4. As a result, the second amplification fiber 10B4 can suppress XPM.

The seventh WDM filter 51G demultiplexes the signal light in the first to fourth wavelength bands amplified by the second amplification fiber 10B4 into signal light in the first and second wavelength bands and signal light in the third and fourth wavelength bands. The seventh WDM filter 51G outputs the demultiplexed signal light in the first and second wavelength bands to the tenth WDM filter 51J in the third amplification unit 6C4, and outputs the demultiplexed signal light in the third and fourth wavelength bands to the eighth WDM filter 51H. The optical power of the signal light in the first wavelength band input to the seventh WDM filter 51G is P2, the optical power of the signal light in the second wavelength band input to the seventh WDM filter 51G is P1, the optical power of the signal light in the third wavelength band input to the seventh WDM filter 51G is P4, and the optical power of the signal light in the fourth wavelength band input to the seventh WDM filter 51G is P3.

The eighth WDM filter 51H demultiplexes the signal light in the third and fourth wavelength bands from the seventh WDM filter 51G into signal light in the third wavelength band and signal light in the fourth wavelength band. The eighth WDM filter 51H outputs the demultiplexed signal light in the fourth wavelength band to the ninth WDM filter 51I, and outputs the demultiplexed signal light in the third wavelength band to the third multiplexing unit 5D3. The optical power of the signal light in the third wavelength band input to the eighth WDM filter 51H is P4, and the optical power of the signal light in the fourth wavelength band input to the eighth WDM filter 51H is P3.

The ninth WDM filter 51I in the third amplification unit 6C4 multiplexes the signal light in the third wavelength band demultiplexed by the third demultiplexing unit 4D3 and the signal light in the fourth wavelength band optically amplified by the second amplification fiber 10B4 and demultiplexed by the eighth WDM filter 51H. The ninth WDM filter 51I multiplexes the multiplexed signal light in the third wavelength band and signal light in the fourth wavelength band, and outputs the multiplexed signal light to the tenth WDM filter 51J. The optical power of the signal light in the third wavelength band input to the ninth WDM filter 51I is P0, and the optical power of the signal light in the fourth wavelength band input to the ninth WDM filter 51I is P3.

The tenth WDM filter 51J multiplexes the signal light in the third and fourth wavelength bands from the ninth WDM filter 51I and the signal light in the first and second wavelength bands optically amplified by the second amplification fiber 10B4 and demultiplexed by the seventh WDM filter 51G. The tenth WDM filter 51J multiplexes the signal light in the first and second wavelength bands and the signal light in the third and fourth wavelength bands, and outputs the multiplexed signal light to the third amplification fiber 10C4. The optical power of the signal light in the third wavelength band input to the tenth WDM filter 51J is P0, the optical power of the signal light in the fourth wavelength band input to the tenth WDM filter 51J is P3, the optical power of the signal light in the first wavelength band input to the tenth WDM filter 51J is P2, and the optical power of the signal light in the second wavelength band input to the tenth WDM filter 51J is P1.

The third amplification fiber 10C4 is, for example, a Raman amplification fiber that optically amplifies the signal light in the first to fourth wavelength bands from the tenth WDM filter 51J and outputs the signal light in the first to fourth wavelength bands after the optical amplification to the eleventh WDM filter 51K. The optical power of the signal light in the first wavelength band output from the third amplification fiber 10C4 is P3, the optical power of the signal light in the second wavelength band output from the third amplification fiber 10C4 is P2, the optical power of the signal light in the third wavelength band output from the third amplification fiber 10C4 is P1, and the optical power of the signal light in the fourth wavelength band output from the third amplification fiber 10C4 is P4.

In the third amplification fiber 10C4, as output, the optical power of the signal light in the first wavelength band is P3, the optical power of the signal light in the second wavelength band is P2, the optical power of the signal light in the third wavelength band is P1, and the optical power of the signal light in the fourth wavelength band is P4. That is, the total power of the third amplification fiber 10C4 is smaller as P10 (= P1 + P2 + P3 + P4) compared to when all wavelength bands are P4. As a result, the third amplification fiber 10C4 can suppress XPM.

The eleventh WDM filter 51K demultiplexes the signal light in the first to fourth wavelength bands amplified by the third amplification fiber 10C4 into signal light in the first and second wavelength bands and signal light in the third and fourth wavelength bands. The eleventh WDM filter 51K outputs the demultiplexed signal light in the first and second wavelength bands to the fourteenth WDM filter 51N in the fourth amplification unit 6D4, and outputs the demultiplexed signal light in the third and fourth wavelength bands to the twelfth WDM filter 51L. The optical power of the signal light in the first wavelength band input to the eleventh WDM filter 51K is P3, the optical power of the signal light in the second wavelength band input to the eleventh WDM filter 51K is P2, the optical power of the signal light in the third wavelength band input to the eleventh WDM filter 51K is P1, and the optical power of the signal light in the fourth wavelength band input to the eleventh WDM filter 51K is P4.

The twelfth WDM filter 51L demultiplexes the signal light in the third and fourth wavelength bands from the eleventh WDM filter 51K into signal light in the third wavelength band and signal light in the fourth wavelength band. The twelfth WDM filter 51L outputs the demultiplexed signal light in the third wavelength band to the thirteenth WDM filter 51M, and outputs the demultiplexed signal light in the fourth wavelength band to the third multiplexing unit 5D3. The optical power of the signal light in the third wavelength band input to the twelfth WDM filter 51L is P1, and the optical power of the signal light in the fourth wavelength band input to the twelfth WDM filter 51L is P4.

The thirteenth WDM filter 51M in the fourth amplification unit 6D4 multiplexes the signal light in the fourth wavelength band demultiplexed by the third demultiplexing unit 4D3 and the signal light in the fourth wavelength band optically amplified by the third amplification fiber 10C4 and demultiplexed by the twelfth WDM filter 51L. The thirteenth WDM filter 51M multiplexes the multiplexed signal light in the third wavelength band and signal light in the fourth wavelength band, and outputs the multiplexed signal light to the fourteenth WDM filter 51N. The optical power of the signal light in the third wavelength band input to the thirteenth WDM filter 51M is P1, and the optical power of the signal light in the fourth wavelength band input to the thirteenth WDM filter 51M is P0.

The fourteenth WDM filter 51N multiplexes the signal light in the third and fourth wavelength bands from the thirteenth WDM filter 51M and the signal light in the first and second wavelength bands optically amplified by the third amplification fiber 10C4 and demultiplexed by the eleventh WDM filter 51K. The fourteenth WDM filter 51N multiplexes the signal light in the first and second wavelength bands and the signal light in the third and fourth wavelength bands, and outputs the multiplexed signal light to the fourth amplification fiber 10D4. The optical power of the signal light in the third wavelength band input to the fourteenth WDM filter 51N is P1, the optical power of the signal light in the fourth wavelength band input to the fourteenth WDM filter 51N is P0, the optical power of the signal light in the first wavelength band input to the fourteenth WDM filter 51N is P3, and the optical power of the signal light in the second wavelength band input to the fourteenth WDM filter 51N is P2.

The fourth amplification fiber 10D4 is, for example, a Raman amplification fiber that optically amplifies the signal light in the first to fourth wavelength bands from the fourteenth WDM filter 51N and outputs the signal light in the first to fourth wavelength bands after the optical amplification to the fifteenth WDM filter 51O. The optical power of the signal light in the first wavelength band output from the fourth amplification fiber 10D4 is P4, the optical power of the signal light in the second wavelength band output from the fourth amplification fiber 10D4 is P3, the optical power of the signal light in the third wavelength band output from the fourth amplification fiber 10D4 is P2, and the optical power of the signal light in the fourth wavelength band output from the fourth amplification fiber 10D4 is P1.

In the fourth amplification fiber 10D4, as output, the optical power of the signal light in the first wavelength band is P4, the optical power of the signal light in the second wavelength band is P3, the optical power of the signal light in the third wavelength band is P2, and the optical power of the signal light in the fourth wavelength band is P1. That is, the total power of the fourth amplification fiber 10D4 is smaller as P10 (= P1 + P2 + P3 + P4) compared to when all wavelength bands are P4. As a result, the fourth amplification fiber 10D4 can suppress XPM.

The fifteenth WDM filter 51O demultiplexes the signal light in the first to fourth wavelength bands amplified by the fourth amplification fiber 10D4 into signal light in the first and second wavelength bands and signal light in the third and fourth wavelength bands. The fifteenth WDM filter 51O outputs the demultiplexed signal light in the third and fourth wavelength bands to the second WDM filter 51B in the first amplification unit 6A4, and outputs the demultiplexed signal light in the first and second wavelength bands to the sixteenth WDM filter 51P. The optical power of the signal light in the first wavelength band input to the fifteenth WDM filter 51O is P4, the optical power of the signal light in the second wavelength band input to the fifteenth WDM filter 51O is P3, the optical power of the signal light in the third wavelength band input to the fifteenth WDM filter 51O is P2, and the optical power of the signal light in the fourth wavelength band input to the fifteenth WDM filter 51O is P1.

The sixteenth WDM filter 51P demultiplexes the signal light in the first and second wavelength bands from the fifteenth WDM filter 51O into signal light in the first wavelength band and signal light in the second wavelength band. The sixteenth WDM filter 51P outputs the demultiplexed signal light in the second wavelength band to the first WDM filter 51A, and outputs the demultiplexed signal light in the first wavelength band to the second multiplexing unit 5D2. The optical power of the signal light in the first wavelength band input to the sixteenth WDM filter 51P is P4, and the optical power of the signal light in the second wavelength band input to the sixteenth WDM filter 51P is P3.

The third multiplexing unit 5D3 multiplexes the signal light in the third wavelength band from the eighth WDM filter 51H and the signal light in the fourth wavelength band from the twelfth WDM filter 51L, and outputs the multiplexed signal light in the third and fourth wavelength bands to the first multiplexing unit 5D1. The optical power of the signal light in the third wavelength band output from the third multiplexing unit 5D3 is P4 and the optical power of the signal light in the fourth wavelength band output from the third multiplexing unit 5D3 is P4.

The second multiplexing unit 5D2 multiplexes the signal light in the second wavelength band from the fourth WDM filter 51D and the signal light in the first wavelength band from the sixteenth WDM filter 51P, and outputs the multiplexed signal light in the second and first wavelength bands to the first multiplexing unit 5D1. The optical power of the signal light in the second wavelength band output from the second multiplexing unit 5D2 is P4 and the optical power of the signal light in the first wavelength band output from the second multiplexing unit 5D2 is P4.

The first multiplexing unit 5D1 multiplexes the signal light in the first and second wavelength bands from the second multiplexing unit 5D2 and the signal light in the third and fourth wavelength bands from the third multiplexing unit 5D3, and outputs the multiplexed signal light to the output unit 3D. The optical power of the signal light in the first wavelength band output from the first multiplexing unit 5D1 is P4, the optical power of the signal light in the second wavelength band output from the first multiplexing unit 5D1 is P4, the optical power of the signal light in the third wavelength band output from the first multiplexing unit 5D1 is P4, and the optical power of the signal light in the fourth wavelength band output from the first multiplexing unit 5D1 is P4.

In the optical amplifier 1D of the fifth example, signal light is demultiplexed into signal light in a first wavelength band, signal light in a second wavelength band, signal light in a third wavelength band, and signal light in a fourth wavelength band. The optical amplifier 1D optically amplifies the signal light in the first wavelength band in the order of the first amplification fiber 10A4, the second amplification fiber 10B4, the third amplification fiber 10C4, and the fourth amplification fiber 10D4. That is, the total power of the fourth amplification fiber 10D4 is smaller as P10 (= P1 + P2 + P3 + P4). As a result, the fourth amplification fiber 10D4 can suppress XPM.

The optical amplifier 1D optically amplifies the signal light in the second wavelength band in the order of the second amplification fiber 10B4, the third amplification fiber 10C4, the fourth amplification fiber 10D4, and the first amplification fiber 10A4. The total power of the first amplification fiber 10A4 is smaller as P10 (= P1 + P2 + P3 + P4). As a result, the first amplification fiber 10A4 can suppress XPM.

The optical amplifier 1D optically amplifies the signal light in the third wavelength band in the order of the third amplification fiber 10C4, the fourth amplification fiber 10D4, the first amplification fiber 10A4, and the second amplification fiber 10B4. The total power of the second amplification fiber 10B4 is smaller as P10 (= P1 + P2 + P3 + P4). As a result, the second amplification fiber 10B4 can suppress XPM.

The optical amplifier 1D optically amplifies the signal light in the fourth wavelength band in the order of the fourth amplification fiber 10D4, the first amplification fiber 10A4, the second amplification fiber 10B4, and the third amplification fiber 10C4. The total power of the third amplification fiber 10C4 is smaller as P10 (= P1 + P2 + P3 + P4). As a result, the third amplification fiber 10C4 can suppress XPM.

The optical amplifier 1D multiplexes the signal light with the optical power P4 in the first wavelength band, the signal light with the optical power P4 in the second wavelength band, the signal light with the optical power P4 in the third wavelength band, and the signal light with the optical power P4 in the fourth wavelength band, and outputs the multiplexed signal light to the output unit 3D. As a result, even when the signal light is wavelength-divided into the signal light in the first to fourth wavelength bands, the nonlinear SNR can be improved.

In the optical amplifier 1D of the fifth example, the case of 4-dividing the wavelength band is described as an example; however, the present disclosure is not limited to 4-division, 3-division or more may be possible, and appropriate modifications are possible. In addition, the wavelength band may be interleaved into a channel band of three channels or more, and appropriate modifications are possible.

The case of the demultiplexing unit including the first demultiplexing unit 4D1, the second demultiplexing unit 4D2, and the third demultiplexing unit 4D3 is described as an example; however, the present disclosure is not limited to this case. For example, a single demultiplexing unit may be configured to demultiplex the signal light into signal light in the first, second, third, and fourth wavelength bands, and appropriate modifications are possible. In addition, the case of the multiplexing unit including the first multiplexing unit 5D1, the second multiplexing unit 5D2, and the third multiplexing unit 5D3 is described as an example; however, the present disclosure is not limited to this case. For example, a single multiplexing unit may be configured to multiplex the signal light with the optical power P4 in the first wavelength band, the signal light with the optical power P4 in the second wavelength band, the signal light with the optical power P4 in the third wavelength band, and the signal light with the optical power P4 in the fourth wavelength band, and appropriate modifications are possible.

For convenience of explanation, a Raman amplification fiber is described as an example of an amplification fiber; however, the present disclosure is not limited to this case and appropriate modifications are possible. For example, as an amplification fiber, a dispersion compensating fiber (DCF), a highly non linear fiber (HNLF), a dispersion shifted fiber (DSF), a single mode fiber (SMF), or the like may be used.

Although amplification fibers such as Raman amplification fibers are exemplified as optical amplifiers, the optical amplifiers are not limited to amplification fibers. For example, semiconductor optical amplifiers (SOAs) or the like may be used and appropriate modifications are possible.

For example, the case in which the optical amplifier 1 is built into an optical communication device such as an OADM is described as an example; however, the optical amplifier 1 may be built into an optical transmitter or into an optical receiver and appropriate modifications are possible.

In the optical amplifier 1, the S-band signal light within the WDM signal is described as an example; however, other wavelength bands such as C-band, L-band, or U-band may be used, for example, and appropriate modifications are possible. The WDM filter is described as an example of a pump WDM filter; however, a circulator or the like may also be used and appropriate modifications are possible.

The case in which the Raman amplification fiber Raman-amplifies optical signals by backward excitation is described as an example; however, forward excitation or bidirectional excitation may be used and appropriate modifications are possible.

In addition, the components of the illustrated units do not necessarily have to be physically configured as illustrated in the drawings. That is, the specific form of dispersion and integration of the units is not limited to those illustrated in the drawings, and some or all thereof can be configured by functionally or physically dispersed and integrated in arbitrary units according to various loads, usage conditions, and the like.

According to one aspect, the nonlinear SNR is improved by wavelength division amplification of signal light.

All examples and conditional language recited herein are intended for pedagogical purposes of aiding the reader in understanding the invention and the concepts contributed by the inventors to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An optical communication device comprising:
a splitter; a first amplifier; a second amplifier; and a combiner, wherein the splitter demultiplexes input signal light into first signal light and second signal light, the first signal light is amplified by the second amplifier after being amplified by the first amplifier, the second signal light is amplified by the first amplifier after being amplified by the second amplifier, and the combiner multiplexes the amplified first signal light and the amplified second signal light.

2. The optical communication device according to claim 1, wherein, in output of the first amplifier, power of the second signal light is greater than power of the first signal light, and in output of the second amplifier, power of the first signal light is greater than power of the second signal light.

3. The optical communication device according to claim 1, wherein the splitter demultiplexes the signal light into the first signal light in a first wavelength band and the second signal light in a second wavelength band.

4. The optical communication device according to claim 1, wherein the splitter demultiplexes the signal light into the first signal light of odd-numbered channels and the second signal light of even-numbered channels.

5. The optical communication device according to claim 1, wherein the splitter demultiplexes the signal light into the first signal light of X-polarization and the second signal light of Y-polarization.

6. The optical communication device according to claim 1, wherein the first amplifier includes: a first optical amplifier configured to amplify the first signal light and the second signal light; a first combiner disposed at a front stage of the first optical amplifier; and a first splitter disposed at a rear stage of the first optical amplifier, the second amplifier includes: a second optical amplifier configured to amplify the first signal light and the second signal light; a second combiner disposed at a front stage of the second optical amplifier; and a second splitter disposed at a rear stage of the second optical amplifier, the first combiner multiplexes the first signal light demultiplexed by the splitter and the second signal light amplified by the second optical amplifier and demultiplexed by the second splitter, and outputs the multiplexed signal light to the first optical amplifier, the first splitter outputs the first signal light out of the first signal light and the second signal light amplified by the first optical amplifier to the second combiner, and outputs the second signal light to the combiner, the second combiner multiplexes the second signal light demultiplexed by the splitter and the first signal light amplified by the first optical amplifier and demultiplexed by the first splitter, and outputs the multiplexed signal light to the second optical amplifier, and the second splitter outputs the second signal light out of the first signal light and the second signal light amplified by the second optical amplifier to the first combiner, and outputs the first signal light to the combiner.

7. The optical communication device according to claim 1, wherein the first amplifier includes: a first optical amplifier configured to amplify the first signal light input from a first direction and the second signal light input from a second direction; and a first splitter disposed at a front stage of the first optical amplifier, the second amplifier includes: a second optical amplifier configured to amplify the first signal light input from the first direction and the second signal light input from the second direction; and a second splitter disposed at a rear stage of the second optical amplifier, the first splitter inputs the first signal light demultiplexed by the splitter to the first optical amplifier, and outputs the second signal light from the first optical amplifier to the combiner, and the second splitter inputs the second signal light demultiplexed by the splitter to the second optical amplifier, and outputs the first signal light from the second optical amplifier to the combiner.

8. The optical communication device according to claim 1, further including: a third amplifier; and
a fourth amplifier, wherein the splitter demultiplexes the signal light into the first signal light, the second signal light, third signal light, and fourth signal light, the first signal light, the second signal light, the third signal light and the fourth signal light are amplified by the first amplifier, the second amplifier, the third amplifier and the fourth amplifier, respectively, and the combiner multiplexes the first signal light, the second signal light, the third signal light, and the fourth signal light.

9. An optical amplifier comprising: a splitter; a first amplifier; a second amplifier; and a combiner, wherein the splitter demultiplexes signal light into first signal light and second signal light,
the first signal light is amplified by the second amplifier after being amplified by the first amplifier, the second signal light is amplified by the first amplifier after being amplified by the second amplifier, and the combiner multiplexes the amplified first signal light and the amplified second signal light.

10. An optical amplification method comprising: demultiplexing, by an optical amplifier, signal light into first signal light and second signal light;
amplifying, by a first amplifier, the demultiplexed first signal light; amplifying, by a second amplifier, the first signal light amplified by the first amplifier; amplifying, by a second amplifier, the demultiplexed second signal light; amplifying, by the first amplifier, the second signal light amplified by the second amplifier; and multiplexing the first signal light amplified by the second amplifier and the second signal light amplified by the first amplifier.
